(19) United States
(12) Patent Application Publication
(10) Pub. No.: US 2005/0053536 A1
(43) Pub. Date: Mar. 10, 2005

(54) Method and apparatus for treating waste gas containing acid and/or base

(76) Inventors: Hung Min Chein, Hsinchu City (TW); Hsin-Hsien Wu, Hsinchu (TW); Shankar Gopala Aggarwal, Kota (IN); Chuen-Jinn Tsai, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/856,064

(22) Filed: May 28, 2004

(30) Foreign Application Priority Data
Sep. 5, 2003 (TW) 92124567

(51) Int. Cl. B01D 53/40; B01J 8/00

(52) U.S. Cl. 423/240 R; 422/168; 422/169

(57) ABSTRACT

A method for treating waste gas containing acid and/or base, employing fine spray-scrubbing technology for treating the waste gas mentioned above, wherein the scrubbing solution is atomized to generate mists with droplet size of 1 to 100 μm. Another feature of the present invention is to combine the application of surfactant in wet scrubbing technology for treating waste gas containing acids, bases, or both, especially, in a low concentration. Another feature of the present invention is to combine spray tower and/or packed tower and/or other scrubbers vertically/horizontally to get enhanced performance of the conventional control systems.

### BACKGROUND OF THE INVENTION

1. Field of the Invention

The present invention relates to a method, and an apparatus for the treatment of waste gas, and in particular to a method and an apparatus for treating waste gas containing acids and/or bases.

2. Description of the Related Art

Waste gas stream results from various industrial processes, such as semiconductor manufacturing process is typically high in flow rate, and contains low concentrations of both acids and bases. Low concentration acidic and basic waste gas pollutants contribute significantly in the total emission of a facility. Wet scrubbing is the conventional technique, widely used to treat the waste gas. Since acids and bases both present in the waste gas stream, the individual treatment, either for acids or for bases is not adequate. The treatment efficiency of conventional wet scrubbers for waste gas containing low concentrations of acids and bases is however poor as the conventional packed towers are designed for highly contaminated waste gas, and/or for treating either acids or bases constituents. Therefore, a better treatment method and apparatus-design is required to control acids and bases emission amount.

U.S. Pat. No. 4,741,890 describes a method of removing sulfur dioxide from flue gases derived from furnaces burning high sulfur content fuels. The method comprises the treatment of the flue gases with spraying an aqueous medium containing a reagent either dissolved or slurried therein, which reacts with sulfur dioxide in the flue gas to produce calcium sulfate and calcium sulfite; and a surfactant to improve the removal efficiency. This method treats high concentration of SOx gas. The method however, cannot treat the waste gas containing both acids and bases.

U.S. Pat. No. 5,160,707 discloses a method and an apparatus for removing ammonia and odorous organic compounds from a composting process air stream, which includes three scrubbing sections. In the first section, a scrubbing solution containing sulfuric acid and a surfactant is sprayed for removing ammonia and organic components. In the second and third section, a bleaching agent and hydrogen peroxide are sprayed, respectively. The air stream is oxidized with bleach to remove sulfides and treated with hydrogen peroxide solution to remove chlorine introduced by the bleach while maintaining the oxidation reaction. With this method and apparatus, however, the waste gas component removal is controlled using sulfuric acid solution, and thus, a waste gas containing both acids and bases cannot be treated.

Hence, there is a need for a method and an apparatus capable of treating a waste gas containing both acids and bases.

### SUMMARY OF THE INVENTION

Accordingly, an object of the invention is to provide a method for treating waste gas containing acids and/or bases, which relates to a scrubbing technique, an integrated scrubbing technique, or an application of the surfactants with scrubbing solutions.

The invention provides a scrubbing method, which includes a fine mist scrubbing technique to treat waste gas containing acids and/or bases, in which a scrubbing solution is atomized to form mist resulting the increase of the gas-liquid contact area, thus the acid and/or base contained in waste gas can be efficiently absorbed or dissolved into the scrubbing solution, hence the performance of the control system is improved.

Furthermore, the invention provides a scrubbing method, which includes an integrated scrubbing technique, comprising the step of passing the waste gas through the scrubbing system which includes one or more scrubbing towers or sections selected from spray, packed, plate, and other type of scrubbing towers or sections in series and in any order.

Furthermore in the method of the present invention, the absorption and dissolution of acid and base components of waste gas into the scrubbing solution can be improved significantly by introducing a particular surfactant in a particular amount into the scrubbing solution. The method is reproducible and provides high removal efficiency, even for waste gas containing low concentrations of acids and bases. Therefore, the method is fulfilled the requirement of an efficient treatment process for waste gas containing acids, bases, or both, particularly in low concentrations.

Another object of the invention is to provide an apparatus for treating high volumetric flow rate waste gas, which is suitable for the treatment of waste gas containing acids, bases, or both, especially in low concentrations.

To achieve the above-mentioned objects of the present invention, the method for treating waste gas containing acid and/or base of the invention comprises the step of passing the waste gas containing acid and/or base through a scrubbing system and contacting the waste gas containing acid and/or base with a scrubbing solution in the scrubbing system, thereby transferring the acid and/or base contained in the waste gas into the scrubbing solution, wherein the scrubbing solution is in the form of mist.

According to another embodiment of the invention, the method for treating waste gas containing acid and/or base comprises the step of contacting the waste gas containing acid and/or base with a scrubbing solution containing a surfactant in at least one wet scrubbing tower, thereby transferring the acid and/or base contained in the waste gas into the scrubbing solution.

The apparatus for treating waste gas containing acid and/or base comprises a wet scrubbing system for receiving the waste gas containing acid and/or base, which comprises a gas inlet and a gas outlet; a scrubbing solution supplier; a first surfactant supplier; a first pH-regulating agent supplier; a first mixing system for receiving and mixing the scrubbing solution from the first scrubbing solution supplier, a surfactant solution from the first surfactant supplier, and optionally a pH-regulating agent solution from the first pH-regulating agent supplier to form a first mixture as a final scrubbing solution; and a first spraying system in the wet scrubbing system for receiving and spraying the final scrubbing solution from the first mixing system to allow the scrubbing of the waste gas containing acid and/or base, thereby transferring the acid and/or base contained in the waste gas into the final scrubbing solution.

According to still another embodiment of the invention, the apparatus for treating waste gas containing acid and/or base comprises a spray tower for receiving the waste gas containing acid and/or base, which comprises a gas inlet and a gas outlet; a scrubbing solution supplier; a pH-regulating agent supplier; a mixing system for receiving and mixing a scrubbing solution from the scrubbing solution supplier and optionally a pH-regulating agent from the pH-regulating agent supplier to form a mixture; and a spraying system in the spray tower for receiving and spraying the mixture from the mixing system to form mists to allow the mixture to contact with the waste gas containing acid and/or base, thereby transferring the acid and/or base contained in the waste gas into the scrubbing solution.

The waste gas containing acids, bases, or both, especially in low concentrations, can efficiently be treated by the method and/or apparatus of present invention. On comparison with conventional technique, the present scrubbing system also integrates different types of scrubbers, such as, vertical or horizontal packed, plate, and spray towers, and has the advantages of improved efficiency, low operating cost, low water consumption, etc.

A detailed description is given in the following embodiments with reference to the accompanying drawings.

### BRIEF DESCRIPTION OF THE DRAWINGS

The present invention can be understood more by reading the subsequent detailed description and examples with references made to the accompanying drawings, wherein:

FIG. 1 is a schematic view of the apparatus in one embodiment of the invention for treating the waste gas containing acid and/or base; and

FIG. 2 is a schematic view of the apparatus for treating the waste gas containing acid and/or base as an example according to the invention.

### DETAILED DESCRIPTION OF THE INVENTION

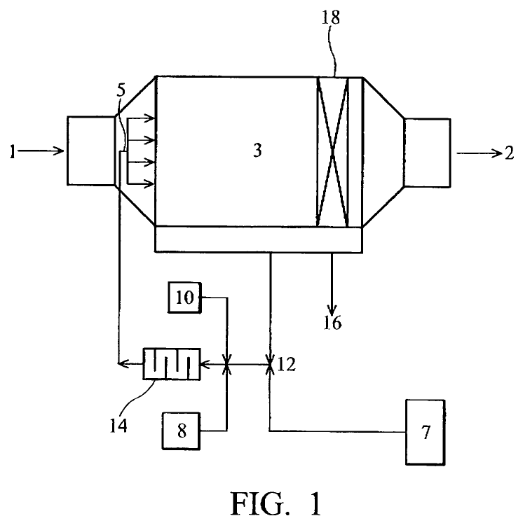

According to the method for treating waste gas containing acid and/or base of the invention, referring to FIG. 1, the waste gas enters a wet scrubbing system 3 through a waste gas inlet 1 and is treated in the scrubbing system with a scrubbing solution, thereby transferring the acid and/or base contained to the scrubbing solution. The treated waste gas is then exhausted through outlet 2.

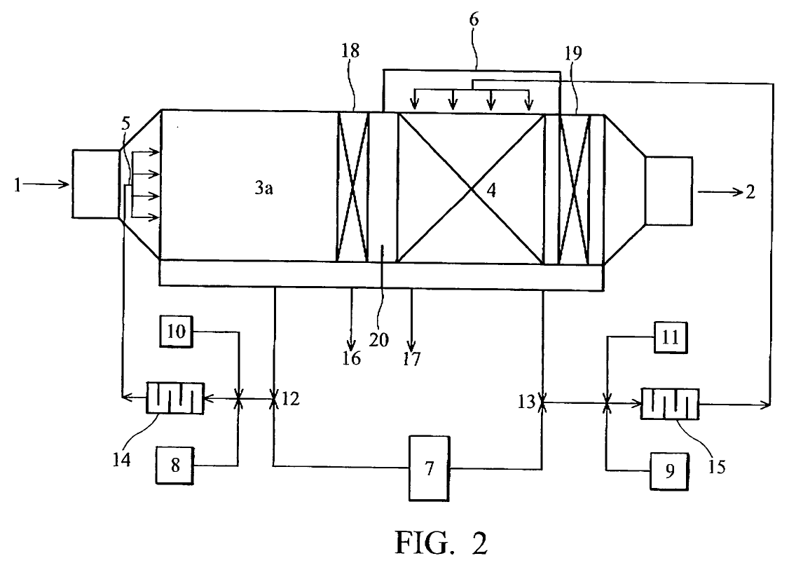

The scrubbing system mentioned above comprises a scrubbing tower, which for example may comprise a single spray tower or a spray tower arranged or integrated in series in any order with one or more selected from a packed tower, a plate tower, another spray tower, and other type of wet scrubbing tower. The scrubbing tower/s may be vertical or horizontal. For example, a horizontal spray tower and a packed tower (as shown in FIG. 2) are integrated in the scrubbing system. The scrubbing system mentioned above may alternatively be an integrated unit having one spray section and one or more selected from another spray, packed, plate tower, and other type of wet scrubbing sections arranged in series in any order. For economic and performance considerations, a spray tower/section and a packed tower/section combined in series are preferred.

One feature of the method of the invention is to treat the waste gas using fine droplet spraying technique as the contact area (area-to-volume ratio) for the waste gas and the scrubbing solution can be increased by the generation of fine mists. Thus the acids and/or bases contained in the waste gas can effectively be absorbed or dissolved.

The scrubbing solution used in the invention is in the form of mist, which is preferrably with droplet sizes ranging from 1 to 1001 m. The mists can be generated using commercially available nozzles, which work on atomization principle. As it is not limited by the current available devices, the mists with droplet size less than 1 μm are also useful in the invention.

The scrubbing solution mentioned above may optionally contain pH-regulating agents, and may be for example, water with appropriate pH, and optionally contain a surfactant. Non-ionic surfactant/anionic surfactant/cationic surfactant/amphoteric surfactant/a mixture thereof can be used in the invention to achieve the desired effect. For example, the non-ionic surfactants are polyethyleneglycol tert-octylphenylether (TX-100), Polyoxyethylene(4) laurylether (Brij-30), and the like. The anionic surfactants are sodiumlauryl sulfate (SLS), sodium dioctylsulfosuccinate (SDS), and the like. The cationic surfactants are cetyltrimethylammonium bromide (CTAB), cetylpyridinium chloride (CPC), and the like. The amphoteric surfactants are dodecyl amino ethyl glycine, oleic acid amide, and the like. The concentration of surfactants in the scrubbing solution is between 0.0000001 M and 0.001M, and preferably between 0.000001 M and 0.001M.

The mechanism of surfactant behavior at the interface can be explained on the basis of the charge phenomenon. In aqueous medium, the hydrocarbon chain of surfactant interacts only very weakly with the water molecules. The strong interactions among the water molecules arising from dispersion forces and hydrogen bonding cooperatively act to squeeze the hydrocarbon chain (hydrophobic chain) out of the water. Whereas, the polar or ionic portion (that is, head-group or hydrophilic head) of the surfactant molecule interacts strongly with water surface via weak forces such as dipole-dipole forces or ion-dipole forces. This head-group generates positive charge (for a cationic surfactant) or negative charge (for an anionic surfactant) or polarizes (for an amphoteric surfactant) the surface of water. Thus some cohesive forces develop at the charged or polar interface, which enhance the contact time, hence the absorption of the gaseous pollutants.

The present invention also provide a method for treating waste gas, which uses a scrubbing solution containing a surfactant in at least one wet scrubbing tower for treating the waste gas containing acid and/or base, thereby transferring the acid and/or base contained in the waste gas to the scrubbing solution. The wet scrubbing tower may be a spray tower, a packed tower, a plate tower, or other type of scrubbing tower, and may further be arranged with one or more towers in series. The wet scrubbing tower may alternatively be one integrated unit having several spray, packed, plate sections, and/or other type of scrubbing sections. The examples and the function of the surfactant used are as mentioned above. The scrubbing solution containing surfactants used in spray tower, packed tower, plate tower or other type of scrubbing tower is found to be more efficient to wash out the acids and/or bases constitutes from the waste gas than the scrubbing solution without surfactants. Furthermore, the scrubbing solution may contain pH-regulating agents or be in a form of mist as mentioned above.

When the spray tower is used in the invention, the gas-liquid ratio is preferably 20,000 to 200,000 m³/m³, and the residence time is preferably 0.5 to 2 seconds. Whereas in packed tower, the specific surface area of the packing material is preferably 90 to 250 m²/m³, the gas-liquid ratio is preferably 200 to 1000 m³/m³, and the residence time is preferably 0.5 to 2 seconds.

The method of the present invention can efficiently and reproducibly treat waste gas containing acids, bases, or both, even in a concentration of an individual species lower than 0.1 ppm. The removal efficiency is found to be between 80% and 95%, significantly higher than the conventional removal efficiencies. The acids mentioned above may be HCl, HF, HNO₃, HNO₂, H₂SO₄, H₃PO₄, and the like. The bases mentioned above may be NH₃ and the like.

The acid and base treatment efficiency can be further improved by selecting the surfactants, concentrations, and the design parameters of the scrubbing towers.

The method of the invention may further include a step of demisting after the contacting step of the waste gas and the scrubbing solution in the form of fine mists in a tower or section. After the step of demisting, recycle and reuse for the used scrubbing solution may be performed.

Referring to FIG. 1, the invention also provides an apparatus for treating waste gas containing acid and/or base, which comprises a wet scrubbing system 3, a scrubbing solution supplier 7, a surfactant supplier 8, a pH-regulating agent supplier 10, a mixing system 14, and a spraying system 5, all of which are described in detail in the following.

The wet scrubbing system 3 comprises waste gas inlet 1 and gas outlet 2.

The scrubbing solution supplier 7 is used for the storage and supply of a scrubbing solution.

The surfactant supplier 8 is used for the storage and supply of a surfactant solution.

The pH-regulating agent supplier 10 is used for the storage and supply of a pH-regulating agent solution.

The mixing system 14 receives and mixes the scrubbing solution from the scrubbing solution supplier 7, the surfactant solution from the surfactant supplier 8, and optionally the pH-regulating agent solution from the pH-regulating agent supplier 10 to form the final scrubbing solution, which then sprays through the spraying system 5 in the spraying section of the wet scrubbing system 3 over the waste gas.

The spray system 5 may comprise one or more atomizers.

The system can further consist of same or other type of scrubbing towers or sections at an upstream and/or downstream side.

For example, FIG. 2 shows a schematic view of the apparatus for treating the waste gas containing acid and/or base, in which a spray tower 3a is connected with a packed tower 4 in series. The scrubbing solutions in both sections contain surfactant to further improve the treatment efficiency.

The apparatus of the invention can be used to treat waste gas containing acids such as HCl, HF, HNO₃, HNO₂, H₂SO₄, H₃PO₄, and the like or the base components such as NH₃ and the like.

In another embodiment of the invention (FIG. 2), the apparatus for treating waste gas containing acid and/or base comprises a spray tower 3a integrated with a packed tower 4 inside one tower, scrubbing solution suppliers 7, surfactant suppliers 8 and 9, pH-regulating agent suppliers 10 and 11, mixing systems 14 and 15, spraying systems 5 and 6, demisters 18 and 19 to demist the waste gas treated, and a separating plate 20 to separated the solution obtained from the demisting.

The invention further provides an apparatus for treating waste gas containing acid and/or base, which comprises a spray tower, a scrubbing solution supplier, a pH-regulating agent supplier, a mixing system, and a spraying system, is described in detail in the following.

The spray tower receives the waste gas and comprises a gas inlet and a gas outlet. The spray tower may be vertical or horizontal and connected with one or more wet scrubbing towers in series in any order. The wet scrubbing tower may be, for example, a spray tower, a packed tower, a plate tower, or other type of wet scrubbing tower and may be vertical or horizontal. The spray tower alternatively may comprise spray section arranged in series in any order with one or more other type of scrubbing sections such as spray, plate, or packed sections.

The scrubbing solution supplier is used for the storage and supply of a scrubbing solution. The scrubbing solution may be, for example, water, or optionally, contain surfactants as described above. The pH-regulating agent suppliers are used for the storage and supply of a pH regulating agent solution. The mixing systems are used for receiving and mixing the scrubbing solution from the scrubbing solution supplier, and optionally the pH-regulating agent solution from the pH-regulating agent supplier to form the final scrubbing solution.

The spraying system (set of nozzles, which work on atomization principle) of spray tower is used for receiving scrubbing solution and to generate the mists, preferably with size ranging from 1 to 100 μm, to allow the better contact area for absorption of waste gas constituents into spraying liquid. However a system for producing turbulence and eddy may be installed in the spray section to increase the gas-liquid contact probability. The spraying system (jet nozzles) of packed tower is used for receiving scrubbing solution and spraying on packing material to allow the absorption process. The apparatus of the invention can be used to treat the acid components such as HCl, HF, HNO₃, HNO₂, H₂SO₄, H₃PO₄, and the like or the base components such as NH₃, and the like of the waste gas.

Furthermore, subsequent to waste gas treatment towers or sections of the apparatus of the invention, the moisture can be removed using, for example, demisters to prevent the absorbed or dissolved pollutants from exhausting or entering the next scrubbing tower or section along with the treated waste gas. For example, demisters may be installed between two scrubbing towers arranged in series, in the rear part of the upstream tower of two scrubbing towers arranged in series, between two scrubbing sections in one tower, in the tower before treated gas exhausting. As the demisters are installed, the scrubbing solution may be recycled and reused independently for each tower or section by installment of recycling systems.

The flow rate of the scrubbing solution may be controlled by a liquid flow controller, and total recycling or partial recycling of the scrubbing solution can be selected by a regulating valve (such as the parts 12, 13 shown in FIGS. 1 and 2). If necessary, the scrubbing solutions can partially or totally be discharged through the discharge control valves 16 and 17.

Furthermore, pH sensors can be installed to automate the pH regulating agent dosing and thus achieving the desired value.

Furthermore, water level sensors are installed for sensing the liquid level for automatic control.

Temperature and moisture sensors can optionally be installed before or after the scrubbing system for detecting and comparing the temperatures and the moistures of the inflow and outflow of the scrubbing system, to maintain the optimum conditions for achieving high performance.

### EXAMPLES

### Example 1

The method according to the present invention was used to treat the waste gas containing low concentrations of acid and base produced from semiconductor manufacturing process, wherein a horizontal spray tower was used. The concentration of NH₃, HCl, and HF in the waste gas used in several runs of treatment is shown in Table 1. The scrubbing solution containing an anionic surfactant (sodiumlauryl sulfate (SLS)) in a concentration of 0.0001 M was used. The droplet size of the spraying mist was less than 100 μm. The gas-liquid ratio was more than 100,000 m³/m³. The residence time was 0.5 seconds. The resulting removal efficiency obtained is shown in Table 1.

TABLE 1

| | Concentration range | |
|---|---|---|
| | before treatment, | Removal |
| Pollutant | ppm | efficiency, % |
| NH₃ | 0.3-3.0 | 70-80 |
| HF | 0.6-2.5 | 70-80 |
| HCl | 0.1-1.0 | 60-80 |

### Example 2

The method according to the present invention was used to treat the waste gas containing low concentration of acid and base produced from semiconductor manufacturing process, wherein a horizontal packed tower was used. The concentration of NH₃, HCl, and HF in the waste gas used in several runs of treatment is shown in Table 2. The scrubbing solution containing a cationic surfactant cetyltrimethyl ammonium bromide (CTAB) in a concentration of 0.000001 M was used. The specific surface area of the packing material was 155 m²/m³. The gas-liquid ratio was more than 500 m³/m³. The residence time was 0.5 seconds. The resulting removal efficiency obtained is shown in Table 2.

TABLE 2

| | Concentration range | |
|---|---|---|
| | before treatment, | Removal |
| Pollutant | ppm | efficiency, % |
| NH₃ | 0.1-1.0 | 65-80 |
| HF | 0.2-0.7 | 65-80 |
| HCl | 0.05-0.5 | 60-75 |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for treating waste gas containing acid and/or base, comprising the step of:
passing the waste gas containing acid and/or base through a scrubbing system and contacting the waste gas containing acid and/or base with a scrubbing solution in the scrubbing system, thereby transferring the acid and/or base contained in the waste gas into the scrubbing solution, wherein the scrubbing solution is in the form of mist.

2. The method as claimed in claim 1, the scrubbing solution is in the form of mist with a drolet size of 1 to 100 μm.

3. The method as claimed in claim 1, wherein the scrubbing system comprises a spray tower.

4. The method as claimed in claim 1, wherein the scrubbing solution contains a surfactant.

5. The method as claimed in claim 1, further comprising a step of recycling and reusing the scrubbing solution.

6. The method as claimed in claim 3, wherein the scrubbing system further comprises a packed, plate, or another spray tower arranged in series with the spray tower.

7. The method as claimed in claim 6, further comprising a step of demisting between the spray tower and the packed, plate, or another spray tower.

8. The method as claimed in claim 7, further comprising a step of independently recycling and reusing the used scrubbing solution in each tower.

9. The method as claimed in claim 8, wherein the scrubbing solution contains a surfactant.

10. The method as claimed in claim 1, wherein the scrubbing system comprises a scrubbing tower having a spray section and a packed, plate, or another spray section.

11. The method as claimed in claim 10, further comprising a step of demisting between the spray section and the packed, plate, or another spray section.

12. The method as claimed in claim 11, further comprising a step of independently recycling and reusing the scrubbing solution in each section.

13. The method as claimed in claim 12, wherein the scrubbing solution contains a surfactant.

14. The method as claimed in claim 1, wherein the waste gas contains at least one selected from the group consisting of HCl, HF, HNO₃, HNO₂, H₂SO₄, H₃PO₄ and NH₃.

15. A method for treating waste gas containing acid and/or base, comprising the step of:
contacting the waste gas containing acid and/or base with a scrubbing solution containing a surfactant in at least one wet scrubbing tower, thereby transferring the acid and/or base contained in the waste gas to the scrubbing solution.

16. The method as claimed in claim 15, wherein the wet scrubbing tower is a spray tower.

17. The method as claimed in claim 16, wherein the scrubbing solution containing a surfactant is in the form of mist.

18. The method as claimed in claim 17, wherein the scrubbing solution containing a surfactant is in the form of mist with a droplet size of 1 to 100 μm.

19. The method as claimed in claim 15, wherein the wet scrubbing tower is a packed tower.

20. The method as claimed in claim 15, wherein the waste gas contains at least one selected from the group consisting of HCl, HF, HNO₃, HNO₂, H₂SO₄, H₃PO₄ and NH₃.

21. An apparatus for treating waste gas containing acid and/or base, comprising:
a wet scrubbing system for receiving the waste gas containing acid and/or base, which comprises a gas inlet and a gas outlet;
a scrubbing solution supplier;
a first surfactant supplier;
a first pH-regulating agent supplier;
a first mixing system for receiving and mixing the scrubbing solution from the first scrubbing solution supplier, a surfactant solution from the first surfactant supplier, and optionally a pH-regulating agent solution from the first pH-regulating agent supplier to form a first mixture as a final scrubbing solution; and
a first spraying system in the wet scrubbing system for receiving and spraying the final scrubbing solution from the first mixing system to allow the scrubbing of the waste gas containing acid and/or base, thereby transferring the acid and/or base contained in the waste gas into the final scrubbing solution.

22. The apparatus as claimed in claim 21, wherein the wet scrubbing system comprises a spray tower.

23. The apparatus as claimed in claim 21, wherein the first spray system comprises at least one atomizer.

24. The apparatus as claimed in claim 23, wherein the at least one atomizer receives the final scrubbing solution from the first mixing system and generates the fine mist.

25. The apparatus as claimed in claim 24, wherein the fine mist has a droplet size in the range of 1 to 100 μm.

26. The apparatus as claimed in claim 22, wherein the wet scrubbing system further comprises a packed, plate, or another spray tower arranged in series with the spray tower.

27. The apparatus as claimed in claim 26, wherein a demister is installed between the spray tower and the packed, plate, or another spray tower.

28. The apparatus as claimed in claim 27, wherein the demister is installed in the spray tower or the packed, plate, or another spray tower.

29. The apparatus as claimed in claim 21, further comprising a recycling system for receiving and recycling the used final scrubbing solution to the first mixing system.

30. The apparatus as claimed in claim 27, further comprising an independent first and a second recycling systems and a second mixing system, a second surfactant supplier, a second pH-regulating agent supplier, and a second spray system, wherein
the first and second recycling systems receive and recycle the used final scrubbing solution from the spray tower and the one of a packed tower and a plate tower respectively to the first mixing system and the second mixing system,
the second mixing system receives and mixes the scrubbing solution from the scrubbing solution supplier, the surfactant solution from the second surfactant supplier, the recycled final scrubbing solution, and optionally a pH-regulating agent solution from the second pH-regulating agent supplier to form a second mixture, and
the first and second spray systems are installed in the spray tower and the one of a packed tower and a plate tower receives and spray the first and second mixture from the first and second mixing system respectively.

31. The apparatus as claimed in claim 30, which treats a waste gas containing at least one selected from the group consisting of HCl, HF, HNO₂, HNO₂, H₂SO₄, H₃PO₄, NH₃, and the combination thereof.

32. The apparatus as claimed in claim 21, which treats a waste gas containing at least one selected from the group consisting of HCl, HF, HNO₃, HNO₂, H₂SO₄, H₃PO₄, NH₃, and the combination thereof.

33. An apparatus for treating waste gas containing acid and/or base, comprising:
a spray tower for receiving the waste gas containing acid and/or base, which comprises a gas inlet and a gas outlet;
a scrubbing solution supplier;
a pH-regulating agent supplier;
a mixing system for receiving and mixing a scrubbing solution from the scrubbing solution supplier and optionally a pH-regulating agent from the pH-regulating agent supplier to form a mixture; and
a spraying system in the spray tower for receiving and spraying the mixture from the mixing system to form mists to allow the mixture to contact with the waste gas containing acid and/or base, thereby transferring the acid and/or base contained in the waste gas to the scrubbing solution.

34. The apparatus as claimed in claim 33, wherein the mists have droplet sizes in the range of 1 to 100 μm.

35. The apparatus as claimed in claim 33, wherein the scrubbing solution contains a surfactant.

36. The apparatus as claimed in claim 33, which treats a waste gas containing at least one selected from the group consisting of HCl, HF, HNO₃, HNO₂, H₂SO₄, H₃?O₄, NH₃, and the combination thereof.

37. The apparatus as claimed in claim 33, which further comprising a wet scrubbing system serially connected to the spray tower.

38. The apparatus as claimed in claim 36, wherein the wet scrubbing system is a packed tower, a spray tower, or a plate tower.

39. The apparatus as claimed in claim 33, further comprising a demister sited downstream of the spray tower to demist the wasted gas treated and a recycling system for receiving and recycling the used scrubbing solution to the mixing system.
